(19) United States
(12) Patent Application Publication
(10) Pub. No.: US 2024/0039680 A1
(43) Pub. Date: Feb. 1, 2024

(54) Feedback Procedures for SL Power Saving UEs

(71) Applicant: Fraunhofer-Gesellschaft zur Foerderung der angewandten Forschung e.V., Munich (DE)

(72) Inventors: Sarun SELVANESAN, Berlin (DE); Baris GOEKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/478,495

(22) Filed: Sep. 29, 2023

Related U.S. Application Data
(63) Continuation of application No. PCT/EP2022/058627, filed on Mar. 31, 2022.

(30) Foreign Application Priority Data
Apr. 1, 2021 (EP) 21166722.5

(51) Int. Cl. H04L 5/00

(52) U.S. Cl. CPC H04L 5/0094; H04L 5/0055; H04W 92/18

(57) ABSTRACT

Transmitter of a (type a) user equipment, UE, wherein the transmitter is configured for a sidelink transmission without sidelink reception; wherein the transmitter is configured to perform random resource selection for the sidelink transmission in a resource pool with random resource selection enabled, wherein the random resource selection is limited to a resource pool with disabled physical sidelink feedback channel.

### CROSS-REFERENCES TO RELATED APPLICATIONS

This application is a continuation of copending International Application No. PCT/EP2022/058627, filed Mar. 31, 2022, which is incorporated herein by reference in its entirety, and additionally claims priority from European Application No. EP 21 166 722.5, filed Apr. 1, 2021, which is incorporated herein by reference in its entirety.

### BACKGROUND OF THE INVENTION

The present application concerns the field of wireless communication systems or networks, like new radio wireless communication systems. Advantageous embodiments refer to approaches for sidelink communications, especially for feedback procedures for sidelink power saving concepts. Embodiments of the present invention concern a user device/user equipment, UE, and feedback procedures for SL (sidelink) power saving UEs.

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 1081, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 1141 to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 1161 to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard, or the IEEE 802.11 standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including space borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard, or the IEEE 802.11 standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station, e.g., GSM, UMTS, LTE base stations, that may not support certain service, like NR V2X services.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(b) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the NR Mode 1 or LTE Mode 3 UEs 152, 154 also NR Mode 2 or LTE mode 4 UEs 156, 158, 160 are present. In addition, FIG. 2(b), schematically illustrates an out of coverage UE using a relay to communicate with the network. For example, the UE 160 may communicate over the sidelink with UE1 which, in turn, may be connected to the gNB via the Uu interface. Thus, UE1 may relay information between the gNB and the UE 160

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements in handling feedback procedures within the sidelink, especially for power saving UEs.

### SUMMARY

An embodiment may have a transmitter of a (type a) user equipment, UE, wherein the transmitter is configured for a sidelink (SL) transmission without sidelink (SL) reception and wherein the transmitter is configured for blind retransmission of a data packet already transmitted using the sidelink (SL) transmission, wherein the number of retransmissions are performed dependent on one or more criteria; or wherein the transmitter is configured to perform random resource selection for the sidelink (SL) transmission, wherein the random resource selection is limited to a resource pool with random resource selection enabled, wherein a physical sidelink (SL) feedback channel is disabled and wherein the transmitter is configured for blind retransmission of a data packet already transmitted using the sidelink (SL) transmission, wherein the number of retransmissions are performed dependent on one or more criteria.

Another embodiment may have a transceiver of a (type B or D) user equipment, UE, wherein the transceiver is configured for a sidelink (SL) transmission with restricted sidelink (SL) reception and/or full sidelink (SL) reception and/or based on a SL DRX configuration; wherein the transceiver is configured to transmit or receive a feedback using only one or more certain timeslots being a proper subset of all available timeslots, wherein the only one or more certain timeslots are defined or indicated by a configuration information.

Another embodiment may have a transceiver of a (type B or type D) user equipment, UE, wherein the transceiver is configured for a sidelink (SL) transmission with restricted sidelink (SL) reception and/or full reception and/or based on a SL DRX configuration, wherein the transceiver is configured to transmit or receive a feedback using an assistance information message.

### BRIEF DESCRIPTION OF THE DRAWINGS

Embodiments of the present invention will be detailed subsequently referring to the appended drawings, in which:

FIG. 1a-b is a schematic representation of an example of a terrestrial wireless network, wherein FIG. 1(a) illustrates a core network and one or more radio access networks, and FIG. 1(b) is a schematic representation of an example of a radio access network RAN;

FIG. 2a-b schematic represents in-coverage and out-of-coverage scenarios, wherein FIG. 2(a) is a schematic representation of an in-coverage scenario in which two UEs directly communicating with each other are both connected to a base station, and FIG. 2(b) is a schematic representation of an out-of-coverage scenario in which the UEs directly communicating with each other,

FIG. 3a shows an example slot format of 3-PSCCH, 3-PSSCH-DMRS and PSFCH to illustrate embodiments;

FIG. 3b shows schematically the relationship between the candidate resources and sensing subframes to illustrate embodiments.

FIG. 4 shows a schematic depiction of TX/RX capabilities of type A/type B/type D power saving UEs to illustrate embodiments;

FIG. 5 shows a table for mapping UE types (A, B, D) and resource pool features according to embodiments;

FIG. 6a, 6b illustrate schematically time slot diagrams for illustrating restriction of feedback transmission to only partial sensing time slots with PSFCH enabled according to embodiments;

FIG. 7 illustrates schematically a time slot diagram including SL DRX cycles for illustrating a feedback transmitted in PSFCH enabled time slots within ON duration according to embodiments;

FIG. 8 illustrates schematically a time slot diagram for illustrating a feedback transmitted in PSFCH enabled time slots outside ON duration according to embodiments;

FIG. 9a shows schematically the principle of AIM used for feedback according to embodiments;

FIG. 9b illustrates schematically the aggregated feedback using AIM according to embodiments;

FIG. 10a schematically represents a user device, UE, in accordance with embodiments of the present invention; and

FIG. 10b illustrates an example of a computer system on which units or modules as well as the steps of the methods described in accordance with the inventive approach may be executed.

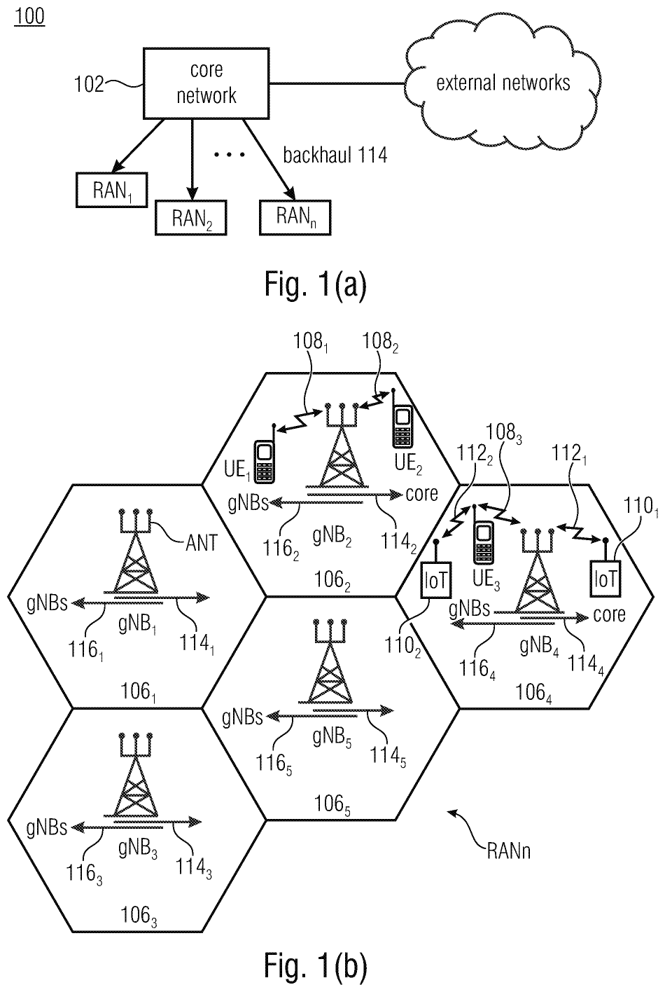

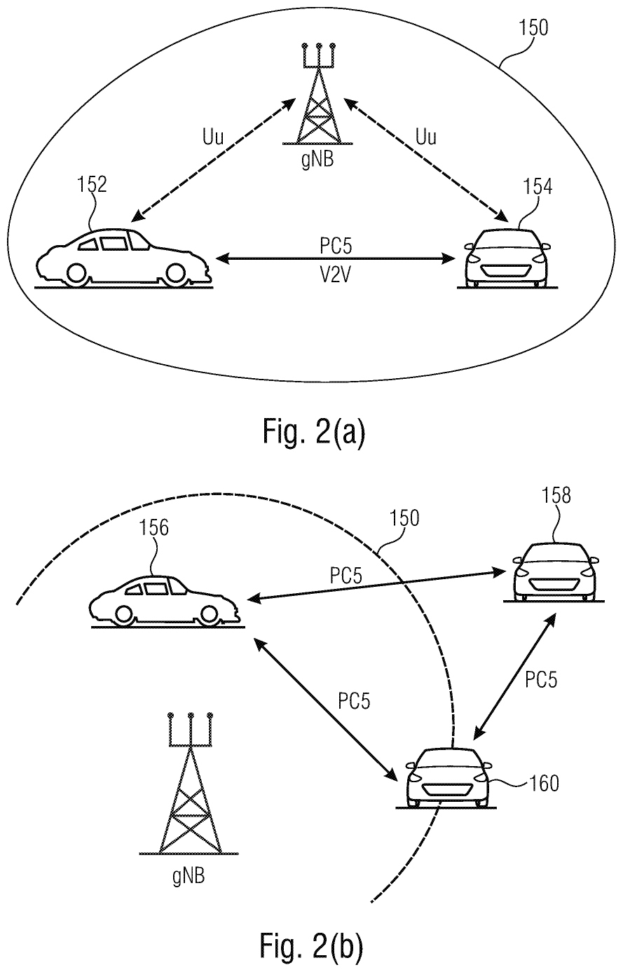

### DETAILED DESCRIPTION OF THE INVENTION

Embodiments of the present invention are now described in more detail with reference to the accompanying drawings in which the same or similar elements have the same reference signs assigned.

Before discussing embodiments of the present invention the problem will be discussed in more detail.

The initial vehicle-to-everything (V2X) specification was included in Release 14 of the 3GPP standard. The scheduling and assignment of resources have been modified according to the V2X requirements, while the original device-to-device (D2D) communication standard has been used as the basis of the design. Release 15 of the LTE V2X standards (also known as enhanced V2X or eV2X) was completed in June 2018, and Release 16, the first release of 5G NR V2X, will be completed in March 2020.

The new Release 17 focuses on sidelink enhancements, with emphasis on power saving, enhanced reliability and reduced latency, to cater to not only vehicular communications, but also public safety and commercial use cases.

In order to meet the new power saving requirements, both the legacy features such as random resource selection and partial sensing have been agreed to be employed to achieve this. However, for ensuring that the reliability is maintained, feedback procedures such as HARQ also needs to be incorporated. This invention explores the different procedures that are required for updating the random resource selection and partial sensing procedures in order to incorporate feedback mechanisms.

In order to understand the details of the invention, the legacy procedures used for power saving in Rel-15, namely random resource selection and partial sensing are described below. In Rel-16, HARQ feedback was introduced as one of the methods to enhance reliability of transmissions, along with blind retransmissions.

Rel-14 LTE-V2X allowed for a power saving UE to not support sidelink reception, so that it is only broadcasting packets relating to its own location and direction (Legacy Power Saving Schemes). This type of UE is allowed to select transmission resources randomly, with no sensing procedure. This is referred to as random resource selection, because the UE randomly selects resources for transmission from a resource pool, due to the fact that it cannot carry out sensing as it has no reception capabilities. For the aforementioned reasons, this solution was agreed to be specified for Rel-17. Such UEs can be a pedestrian UE, like a handheld mobile phone, which transmits its location at regular intervals, Roadside Units (RSU) and sensors that are configured to transmit certain road, traffic and weather conditions at regular intervals, etc.

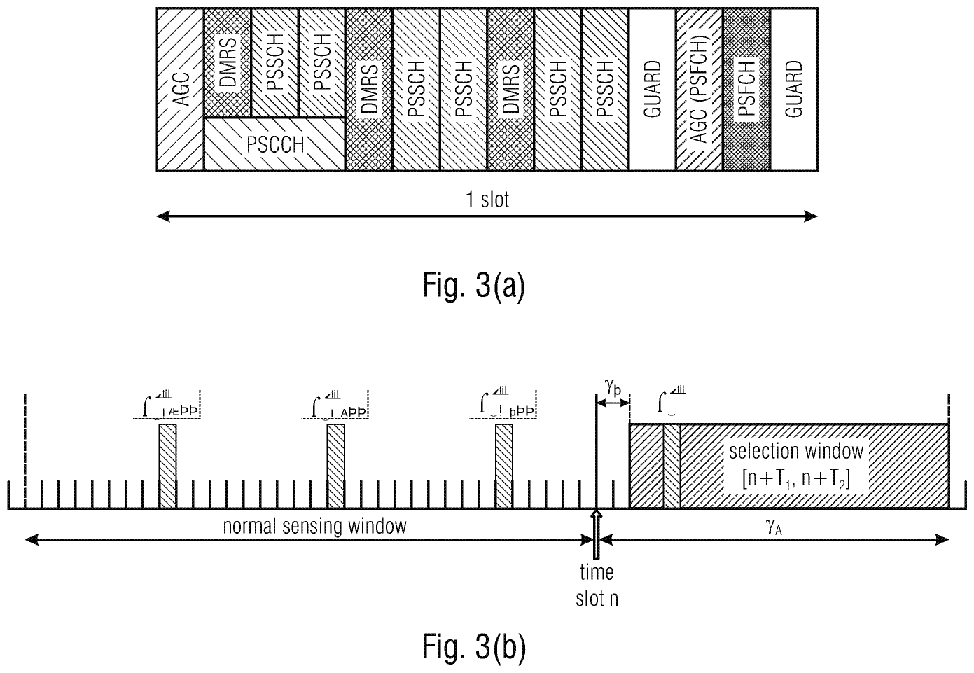

For a power saving UE which does support sidelink reception, it can be (pre-)configured to perform partial sensing. In partial sensing, only a subset of the subframes in the sensing window have to be monitored. In LTE, periodic traffic is dominant, and thus a power-saving UE triggers resource selection at every time interval. A UE determines a set of subframes t_{y}^{SL}, where y=1, 2, . . . , Y, within the resource selection window, [n+T₁, n+T₂]. The time interval between two consecutive time resource selections is scaled by the step size P_step which for FDD is set to 100 ms. The monitored subframes are determined by t_{y-k×P}_{ₛₜₑₚ}^{SL} if the k-th bit of the higher layer parameter gapCandidateSensing is set to 1. The relationship between the candidate resources and sensing subframes is shown in FIG. 3b The step size of 100 ms worked well for LTE V2X due to the fact that the traffic was predominantly periodic and the possible periodicities were defined in steps of 20 ms, 50 ms or multiples of 100 ms. (Pre-)configuration can also set how far into the past the sensing window extends, and can require that the UE performs partial sensing in a number of these truncated sensing windows.

In adapting this solution to Rel-17 and the different resource reservation options, it is being discussed to use the list of periodicities to define the sensing time slots consisting of the partial sensing window.

PSFCH (Physical Sidelink Feedback Channel) carries HARQ feedback over the sidelink from a UE which is an intended recipient of a PSSCH transmission (RX UE) to the UE which performed the transmission (TX UE). Sidelink HARQ feedback may be in the form of conventional ACK/NACK, or NACK-only with nothing transmitted in case of successful decoding. PSFCH transmits a Zadoff-Chu sequence in one PRB repeated over two OFDM symbols, the first of which can be used for AGC, near the end of the sidelink resource in a slot. An example of the slot format structure can be seen in FIG. 3.

FIG. 3 shows an example of a slot format, wherein the single blocks (AGC, DMRS, PSSCH, PSCCH, etc.) can be interpreted as a subchannel across frequency and symbols within a single time slot across time.

The time resources for PSFCH are (pre-)configured to occur once in every 1, 2, or 4 slots. Frequency/code resources are derived implicitly from those used by the associated PSSCH transmission, together with the L1 identity of the UE transmitting PSSCH and, when groupcast with ACK/NACK feedback is used, the identity within the group of the UE transmitting on the PSFCH.

The PSFCH is configured per resource pool, within the SL-ResourcePool information element (IE). The parameters within the SL-ResourcePool information element which are relevant to teachings enclosed herewith are underlined:

-- ASN1START
-- TAG-SL-RESOURCEPOOL-START

| | |
|---|---|
| SL-ResourcePool-r16 ::= | SEQUENCE { |

...

| | | |
|---|---|---|
| sl-PSFCH-Config-r16 | SetupRelease { SL-PSFCH-Config-r16 } | OPTIONAL, -- Need M |

...
}

| SL-PSFCH-Config-r16 ::= | SEQUENCE { | |
|---|---|---|
| sl-PSFCH-Period-r16 | ENUMERATED {sl0, sl1, sl2, sl4} | OPTIONAL, -- Need M |
| sl-PSFCH-RB-Set-r16 | BIT STRING (SIZE (10..275)) | OPTIONAL -- Need M |
| sl-NumMuxCS-Pair-r16 | ENUMERATED {n1, n2, n3, n6} | OPTIONAL -- Need M |
| sl-MinTimeGapPSFCH-r16 | ENUMERATED {sl2, sl3} | OPTIONAL -- Need M |
| sl-PSFCH-HopID-r16 | INTEGER (0..1023) | OPTIONAL, -- Need M |

| | |
|---|---|
| sl-PSFCH-CandidateResourceType-r16 ENUMERATED {startSubCH, allocSubCH} | OPTIONAL, -- |

Need M
...
}

Below, some descriptions of relevant parameters are given:

sl-PSFCH-CandidateResourceType indicates the number of PSFCH resources available for multiplexing HARQ-ACK information in a PSFCH transmission (see TS 38.213 [13], clause 16.3).

sl-PSFCH-Period indicates the period of PSFCH resource in the unit of slots within this resource pool. If set to s10, no resource for PSFCH, and HARQ feedback for all transmissions in the resource pool is disabled.

sl-PSFCH-RB-Set indicates the set of PRBs that are actually used for PSFCH transmission and reception. The leftmost bit of the bitmap refers to the lowest RB index in the resource pool, and so on.

Rel-16 NR-V2X supports HARQ (sidelink HARQ) based on transmission of ACK/NACK for sidelink unicast and groupcast services, as well as a NACK-only HARQ scheme particular to groupcast services. In addition, it supports blind re-transmission schemes for Mode 1 and Mode 2, where the TX UE reserves resources for the retransmission of a TB, and these resources are indicated in the SCI.

When ACK/NACK operation is used, the sidelink HARQ procedure is similar to the Uu scheme for non-codeblock group or transport block-based feedback, i.e. the HARQ feedback is transmitted based on the success or failure of the whole transport block.

NACK-only operation is defined for groupcast to allow a potentially lower sidelink resource demand to be created when a larger number of RX UEs need to send feedback to the same TX UE. A typical use case is an extended sensors scenario where UEs within a given radius all receive the same sensor information from the TX UE, and re-transmission will occur if any UE fails to decode successfully. Since such information may only be relevant within a given radius around the TX UE (e.g., a few tens or hundreds of meters around a road junction), the transmission of NACK-only feedback can be restricted to UEs within such a radius, and any UE beyond it does not provide any HARQ feedback. The minimum range requirement of a service is provided together with the associated QoS parameters from service layers.

One bit of sidelink HARQ feedback is carried on PSFCH from an RX UE to its TX UE. In addition, when under the control of a gNB in resource allocation mode 1, the TX UE informs the gNB via PUCCH or PUSCH of the status of the sidelink HARQ feedback it has computed related to a particular dynamic or configured grant to assist the scheduling of re-transmissions and allocation of sidelink resources.

The maximum number of retransmissions allowed by a TX UE for a given TB is defined by the SL-PSSCH-TxConfigList/E, which is seen below. The maximum number is restricted to up to 32 retransmissions. The parameters of an example SL-PSSCH-TxConfigList information element relevant to teaching enclosed herewith are underlined.

| -- ASN1START | |
|---|---|
| -- TAG-SL-PSSCH-TXCONFIGLIST-START | |
| SL-PSSCH-TxParameters-r16 ::= | SEQUENCE { |
| sl-MinMCS-PSSCH-r16 | INTEGER (0..27), |
| sl-MaxMCS-PSSCH-r16 | INTEGER (0..31), |

| | |
|---|---|
| sl-MinSubChannelNumPSSCH-r16 | INTEGER (1..27), |
| sl-MaxSubchannelNumPSSCH-r16 | INTEGER (1..27), |

| sl-MaxTxTransNumPSSCH-r16 INTEGER (1..32), | |
|---|---|
| sl-MaxTxPower-r16 SL-TxPower-r16 | OPTIONAL -- Cond CBR |

}

Relevant SL-PSSCH-TX config list field parameters will be described below.

sl-MaxTxTransNumPSSCH indicates the maximum transmission number (including new transmission and retransmission) for PSSCH.

sl-MaxTxPower indicates the maximum transmission power for transmission on PSSCH and PSCCH.

sl-MinMCS-PSSCH, sl-MaxMCS-PSSCH indicates the minimum and maximum MCS values used for transmissions on PSSCH.

sl-MinSubChannelNumPSSCH, sl-MaxSubChannelNumPSSCH indicates the minimum and maximum number of sub-channels which may be used for transmissions on PSSCH.

Rel-17 work is currently ongoing for adaption of random resource selection and partially sensing for the new release. The following are a set of agreements, conclusions and proposals that were made and are relevant to teachings enclosed herein.

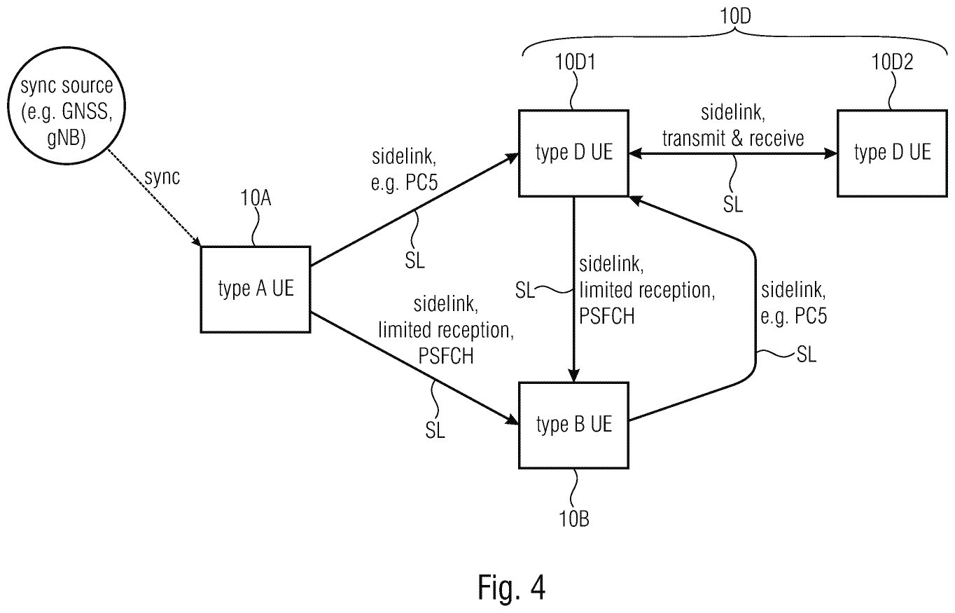

SL reception type A and type D should be used as a reference for the evaluation of designing of SL power saving features in Rel-17. Here a differentiation between type A UEs, type B UEs and type D UEs is made. The different types are illustrated by FIG. 4. The type A UE is marked by 10A, the type D UE is marked by 10D and the type B UE is marked by 10B.

As can be seen, the type A UE 10 is configured to transmit signals using the sidelink, i.e., to perform sidelink transmission, e.g., PC5 as illustrated by the transmission arrows to the UE 10D or 10B. The type A UE 10A is not capable of performing reception of any SL signals and channels:
PSFCH reception is not included for type A UE 10
S-SSB reception is not included for type A UE 10A

However, as illustrated a type A UE 10A can optionally receive a signal from a GNSS or a gNB, like a signal for determining the current position or to be used as sync signal (sync cells). An example of a type A UE 10 may be a sensor which is configured to transmit sensor signals, e.g., within regular time frames.

A type B UE 10B is the same as the type A UE with an exception of performing PSFCH and S-SSB reception. This is illustrated in that type B UE 10B can perform sidelink communication as sidelink transmission, e.g., using PC5 and has limited reception capabilities, e.g., can transmit or receive the physical sidelink feedback channel (PSFCH).

The type D UE 10D can perform full sidelink communications, i.e., transmitting data via sidelink (cf. communication between 10D1 and 10D2) and is furthermore capable of performing reception of all SL signals and channels defined in Rel-16. It does not preclude the UE to perform reception of a subset of SL signals/channels.

To summarize, in the below discussion a differentiation between type A UE (cf. 10A), type B UE (cf. 10B) and type D UE (cf. 10D) is made. All UEs are assumed to be configured to perform a sidelink transmission, wherein only the type D UE is configured to perform full sidelink reception, while the type B UE is configured to perform limited sidelink reception, e.g., PSFCH. According to embodiments, all UEs 10A, 10B and 10D may be configured to receive signals, e.g., data or configurations from a base station, like a gNB over the Uu interface.

The current agreements and proposals for the current standard will be discussed: Agreements:
Partial sensing based RA is supported as a power saving RA scheme
   FFS details
Random resource selection is supported as a power saving RA scheme
   FFS any changes or enhancement
   FFS on conditions to apply random resource selection
Random resource selection is applicable to both periodic and aperiodic transmissions
   FFS conditions for random resource selection
In R17, a SL Mode 2 Tx resource pool can be (pre-)configured to enable full sensing only, partial sensing only, random resource selection only, or any combination(s) thereof
   FFS details, including usage, potential restrictions, whether/how any enhancement or condition is needed for the coexistence of full sensing and power saving RA scheme(s) in a same resource pool, etc.

Proposals:
R1-2008373—Sony
   Proposal 4: If HARQ feedback in unicast and groupcast is supported in partial sensing, the number of the partial sensing/candidate slots should be determined based on HARQ related parameters.
R1-2008998—Intel
   Proposal 11: Capability of UE to provide sidelink feedback information over Uu or PC5 interfaces (e.g. HARQ feedback, CSI report and/or RSRP measurements) is associated with UE power saving state(s) (or state IDs) (i.e. configured per UE power saving state)
   UE indicates its power saving state to other UEs and to serving gNB
R1-2009072—Ericsson
   Observation 9: Adapting the partial sensing window by using HARQ feedback allows adjustments according to the actual channel conditions and optimize power consumption of the UE. Moreover, the impact on specification is minor due to re-using existing mechanisms.
   Proposal 9: The sensing window of a UE performing partial sensing is adapted based on previous HARQ feedback (ACK or NACK) and can be increased if NACK is received or reduced if ACK is received.
R1-2100672—Intel
   Proposal 1: UE performing random resource selection should respect PSSCH to PSFCH HARQ time gap, if UE monitors PSFCH and requests for sidelink HARQ feedback, otherwise the gap can be ignored
   UE ensures a minimum time gap Z between any two selected resources of a TB where a HARQ feedback for the first of these resources is expected
   Proposal 2: UE performing partial sensing, should respect PSSCH to PSFCH HARQ time gap, if UE monitors PSFCH and requests for sidelink HARQ feedback, otherwise the gap can be ignored.
   Proposal 5: UEs using partial sensing or random resource selection for transmissions with enabled HARQ feedback are required to monitor the associated PSFCH resources
R1-2100517—LG
   Proposal 12: PSFCH resources associated with the randomly selected resources are separately configured from those for full/partial sensing based selected resources

Based on the information listed above, it becomes clear that no feedback procedure has been specified. In this invention, we intend to address the different feedback procedures that can be employed for each of the power saving schemes of random resource selection as well as partial sensing.

For the sidelink communication, some approaches for ensuring the transmission reliability are known. For example, a successful or broken transmission may be confirmed by a feedback, ACK or NACK (cf. HARQ process). In case of a NACK the current data packet can be retransmitted. According to another approach, a blind retransmission (HARQ-less retransmission) can be performed. All these approaches (HARQ or quasi HARQ process or blind retransmission) may have a negative influence to the energy efficiency, since the retransmission or the capability for receiving the feedback causes additional energy loss. Therefore, there is a need for an improved approach. Below, five different concepts for improving energy efficiency while maintaining the transmission reliability will be discussed.

The aspects 1 and 2 are applicable mainly to type A UEs, while the aspects 3, 4 and 5 are applicable to type B and type D UEs. Of course, the aspects 1 and 2 may also be applicable to type B and type D UEs, since type B and D UEs are UEs enhanced by additional features.

Below, these concepts will be discussed separately, where it should be mentioned that a combination of these aspects is also possible.

The following restrictions and enhancements enable that feedback procedures work effectively alongside the power saving schemes:
Feedback solutions for Type A UEs (no reception) using random resource selection
   Aspect 1: Restricting the transmissions by these UEs to a resource pool with PSFCH disabled
   Aspect 2: Linking the number of retransmissions to the priority of the TB being transmitted
Feedback solutions for Type B (restricted reception) and D UEs (all reception) using partial sensing
   Aspect 3: Restricting the transmission of the HARQ feedback to only certain time slots, based on a pre-defined criteria
Feedback solutions in alignment with DRX ON durations
   Aspect 4: Permitting/restricting the reception of HARQ feedback based on the DRX configuration of the TX UE
Feedback solutions using assistance messages
   Aspect 5: Using the AIMs to transmit consolidated/aggregated feedback Details regarding each of the ideas are seen in the following respective sections.

### Aspect 1—Restricting the Transmission by these UEs to a Resource Pool with PSFCH Disabled

Embodiments of Aspect 1 of the present invention refer to a transmitter of a (type A) user equipment 10A (UE). Here the transmitter is configured for a sidelink transmission without sidelink reception. The transmitter is configured to perform random resource selection for the sidelink transmission in a resource pool with random resource selection enabled, wherein the random resource selection is limited to a resource pool with disabled physical sidelink feedback channels (PSFCH disabled).

Since the transmitter of type A is not enabled to receive data via the sidelink, it makes sense that these transmitters only use a limited resource pool, where no physical sidelink feedback is transmitted. At the receiver of the sidelink transmission, i.e., a type D UE 10D, energy can be saved since it does not have to transmit a feedback, wherein energy at least at the UE having receiving capabilities is saved.

Based on the agreements made in RAN1, a Rel-17 resource pool can be configured or pre-configured to enable either random resource selection alone, or in combination with full or partial sensing. Immaterial of which power saving feature is enabled in a resource pool, Type A UEs cannot receive any transmissions, including PSFCH. For Type A UEs to carry out random resource selection in a resource pool with PSFCH enabled will result in wastage of resources in the PSFCH.

Hence, according to embodiments it is proposed that Type A UEs 10A use only resources pools that have the PSFCH disabled. Such resource pools will have only random resource selection enabled as a power saving feature. In other words, all resource pools with only random resource selection enabled should have PSFCH disabled. In the case of a combined power saving resource pool configuration with PSFCH disabled, UEs that are carrying out transmissions with feedback disabled can use the resource pool, while carrying out full/partial sensing. This would restrict the number of UEs that are carrying out full/partial sensing, thereby managing the resource collisions that could take place when both random resource selection and partial sensing UEs co-exist in the same resource pool.

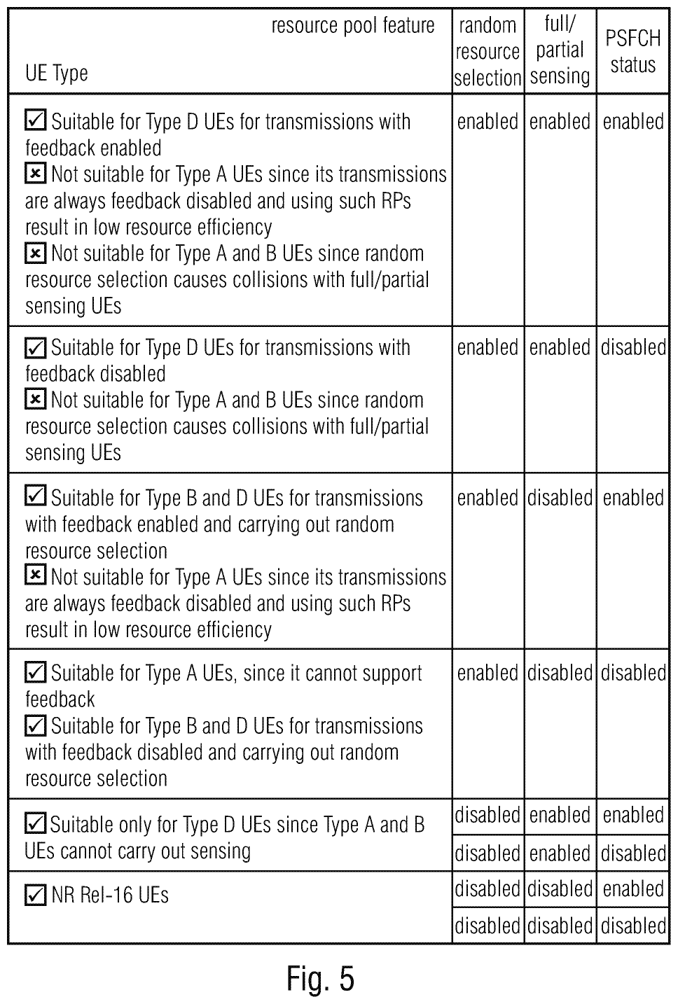

This can easily be achieved in the specifications by introducing a condition in the data transmission procedure, where type A UEs are restricted to select and transmit in resource pools with PSFCH disabled. A snapshot of the correlation between the UE types (A, B, D) and the resource pool features that are suitable can be seen in the table of FIG. 5.

According to embodiments, the resource pool is preconfigured by a pre-configuration or configured by a known configuration, e.g. initially programmed, stored on a SIM card or received via the Uu interface. Here the configuration may define a resource pool with one or more of the following characteristics:
PSFCH disabled and/or resources of the resource pool with PSFCH disabled, and/or
random resource selection enabled.

Note, that the transmissions are not limited to these resources (where the PSFCH would have been), but can use all available resources within the resource pool.

According to an embodiment, a pre-configuration or configuration of the resource pool comprises a flag indicating that the resource pool with PSFCH disabled is usable just for transmissions with disabled feedback.

According to embodiments, the resource pool with PSFCH disabled and random resource selection enabled is useable only for user equipments having feedback disabled, or are not capable of transmitting packets with feedback enabled, while carrying out random resource selection, such as type A UEs. Conversely, user equipments having feedback enabled such as type B or D UEs, should not use such a resource pool with PSFCH disabled and random resource selection enabled. Nevertheless, user equipments which are—at least with respect to the hardware—configured for receiving/exchanging feedback, may according to further embodiments use these resources when said feedback functions are disabled.

According to embodiments, a user equipment may be comprised of the above defined transmitter. Therefore, an embodiment refers to a use equipment. According to further embodiments, the user equipment comprises a sensor, like a GNSS sensor, or a receiver for receiving a signal, like a synchronization signal, from a synchronization source or synchronization signal of a base station or gNB. Furthermore, the user equipment may be capable of transmission and reception, i.e., exchanging data to a base station (gNB), especially using the Uu interface.

According to embodiments, this concept may be performed by a method. The method comprises the following steps:
performing sidelink transmission without sidelink reception with random resource selection enabled;
performing random resource selection for the sidelink transmission, wherein the random source selection is limited to a resource pool with disabled physical sidelink feedback channels (PSFCH disabled).

This discussed approach is mainly applicable to user equipment 10A of type A or operated as a type A user equipment.

The below discussed approach is also applicable to user equipment of type A.

### Aspect 2—Linking the Number of Retransmissions to the Priority of the TB being Transmitted or in General to a Criteria

Embodiments of the present invention provide a transmitter of a type A user equipment 10A, where the transmitter is configured for sidelink transmission without sidelink reception. Furthermore, the transmitter is configured for blind or HARQ-less retransmissions of a data packet already transmitted using the sidelink transmission. Here, the number of retransmissions are performed dependent on one or more criterion, like the priority. According to embodiments, the criterion are out of the group comprising the following
a priority for the data packet,
one or more characteristics of a packet of a transmission,
a logical channel used for a transmission,
a logical channel group used for a transmission,
a quality of service, QoS, flow,
a quality of service, QoS, requirement associated with a transmission, like a priority or delay or data rate,
the type of UE, e.g. Vehicular UE (V-UE), Public Safety UE (PS-UE), Industrial IoT UE (IIoT UE), low power UE, etc.
one or more resources to be used by an initial transmission and/or at least one further transmission,
the cast type, e.g., unicast, groupcast or broadcast, used for the initial transmission,
a current battery status of the UE.

Note, also a combination of two or more criterion may be used.

Embodiments of this aspect are based on the finding the ideal balance between reliability and power saving. Blind retransmission can be performed in a very reliable way at the expense of low resource efficiency and more power consumption, e.g., when a plurality of retransmissions are performed, or in a less reliable way but maximizing power saving, e.g., when none or only one retransmission is performed. In order to determine the ideal number of retransmissions, the criterion has to be set. An example is the QoS requirement of the transmission. When performing only as many retransmissions as is required, energy can be saved. Furthermore, if the transmission is of high importance, the number of retransmissions is increased so as to increase the transmission reliability.

Since Type A UEs cannot receive the PSFCH, the only solution left to achieve reliability is by using blind retransmissions. Currently, the number of blind retransmissions has to be configured, e.g., 3. A chain reservation of retransmissions is also possible. The number of retransmissions is configured in the sl-MaxTxTransNumPSSCH parameter present in the SL-PSSCH-TxConfigList information element (IE).

In order to ensure reliability requirements, the number of retransmissions including or excluding the initial transmission could according to embodiments be linked to the priority of the message from Type A UEs, e.g., alert/security messages are sent with larger number or retransmissions. Accordingly, we propose to introduce a new parameter in the SL-PSSCH-TxConfigList IE that maps the maximum number of retransmissions including or excluding the initial transmission possible per priority value for Type A UEs. The parameter can be a vector of length 8, with the value of each index corresponding to each of the 8 priority levels. An example of this is seen below:

SL-PSSCH-TxConfigList information element:

-- ASN1START
-- TAG-SL-PSSCH-TXCONFIGLIST-START

| | |
|---|---|
| SL-PSSCH-TxParameters-r17 ::= | SEQUENCE { |

...

| | |
|---|---|
| sl-PS-MaxTxTransNumList-r17 | SEQUENCE (SIZE (1..8)) OF SL-PS-MaxTxTransNum-r17 |

| | |
|---|---|
| SL-PS-MaxTxTransNum-r17 ::= | SEQUENCE { |

| | |
|---|---|
| sl-Priority-r16 | INTEGER (1..8), |

| | |
|---|---|
| sl-PS-MaxTransNum-r17 | INTEGER (1..32) |

}
OPTIONAL -- Cond CBR
}

sl-PS-MaxTxTransNumList indicates the maximum number of times that a TB can be transmitted or retransmitted using the resources provided by the resource pool with random resource selection enabled. sl-Priority corresponds to the logical channel priority.

According to embodiments, when the transmitter performs the retransmissions, the number of retransmissions including or excluding the initial transmission is dependent on the priority; alternatively or additionally the retransmissions are performed n times, with 0<=n<=nᵣₑₜᵣₐₙₛₘᵢₛₛᵢₒₙₛ, where, for example, nᵣₑₜᵣₐₙₛₘᵢₛₛᵢₒₙₛ=32, wherein n is configured for each of the priority classes (e.g. 8 priority classes as in 5QI) or another priority relevant information, i.e. the minimum number of retransmissions is 0 or 1 or advantageously greater than 1. The number of retransmissions can also be based on any of the aforementioned criterion, in order to maximize power saving while ensuring reliability.

According to embodiments, the number of retransmissions performed by the transmitter can be configured based on a configured or pre-configured priority threshold. In this case, there will be at least two values of n that will be configured or pre-configured—one is the number of retransmissions that will be carried out by the UE if the priority is above the threshold, and one is when the priority is below the threshold. This will avoid the configuration of n for each of the priorities, but can still vary the number of retransmissions based on the priority of the packet being transmitted.

According to further embodiments, the priority depends on the content of the data packet; alternatively or additionally the priority is set to high for a data packet comprising an emergency information, set to normal for a data packet comprising regular data transmission (like a status information) or set to low for low important content (like an iterative information/iterative measurement information).

According to embodiments, the number of retransmissions is dependent on a configuration information where a maximum number of retransmissions is mapped to each of the different priority classes or another priority relevant information).

Another embodiment refers to a user equipment being comprised of the above defined transmitter. The user equipment may comprise a sensor, a GNSS sensor or a receiver for receiving a signal of a synchronization source or a synchronization signal of a base station (gNB); the user equipment may be capable of transmission and reception to a base station, especially using the Uu interface.

According to embodiments, a method for performing a sidelink transmission by use of a (type A) user equipment 10A is provided. The method comprises the steps:
performing the sidelink transmission without sidelink reception; and
performing a (blind) retransmission of a data packet already transmitted using the sidelink transmission;

Here, the number of retransmissions are performed dependent on one or more criteria.

Note that according to embodiments, a combination of aspect 1 and aspect 2 is possible.

### Aspect 3—Restricting the Transmission of the HARQ Feedback to Only Certain Time Slots, Based on Pre-Defined Criteria

Another embodiment provides a transceiver of (type B or type D) the UE. Here, the transceiver is configured for sidelink transmission with restricted sidelink reception or full link reception. The transceiver is configured to transmit or receive a feedback or HARQ feedback. In case of transmitting, the transceiver 10B, which is meant to receive a data transmission, generates the feedback/HARQ feedback and transmits this feedback signal. In case of receiving the feedback/HARQ feedback, the transceiver 10D refers to a UE that carried out the data transmissions and is waiting for the feedback signal. The feedback is transmitted or received using one or more certain time slots being a proper subset of all available time slots, wherein only the one or more certain time slots are defined or indicated by a configuration information like a resource pool configuration.

Based on the resource pool configuration, all UEs operating in a given resource pool are aware of the time slots in which the PSFCH is enabled, and the time gap required for processing from the time the transmission took place, to the time the feedback is to be expected. When a UE is carrying out partial sensing, the UE is receiving only the time slots in which it carries out partial sensing for power saving. Hence, it is logical that the UE that received the data transmission, sends the feedback during the partial sensing time slots. Alternatively, different conditions may be used, for example, a limitation that the timeslots are within the packet delay budget (PDB), which ensures that the feedback is sent to the transmitting UE before the PDB expires. This is so that in the case of the feedback being a NACK (unsuccessful reception), the transmitting UE has adequate time to retransmit before the expiry of the PDB. Note, in the sense of the claim timeslot may be interpreted as entire slot or as part of a slot, e.g., as one or more symbols within a respective slot.

Below, the background will be discussed. In the case of Type B or Type D UEs, they are capable of receiving HARQ feedback, but differ in the sense that may not and may receive normal transmissions respectively, due to type B UEs not being able to receive the PSCCH or PSSCH. The current Rel-16 procedure dictates that the UE has to monitor all PSFCH time slots that are relevant to the UE, based on transmissions that the UE carried out.

For example, in the case of Type D UEs carrying out partial sensing, the reason that the UE carries out partial sensing is so that it does not have to monitor the PSCCH or receive any SCI outside of the partial sensing time slots. Instead of expecting a TX UE to monitor the PSFCH time slots in addition to PSCCH partial sensing time slots, we propose that the TX UE indicates to the RX UE that the feedback has to be sent in one of the time slots that the UE will be monitoring as part of the partial sensing window/time slots.

According to embodiments, an additional flag in the SCI or an additional parameter in SL-PSFCH-Config-r16 indicating to the RX UE that it has to transmit the HARQ feedback in only those time slots that meet the following criteria:
The time slot is one of the partial sensing time slots,
The time slot is one with PSFCH configured, based on sl-PSFCH-Period-r16,
The time slot is within the PDB of the transmitted TB.

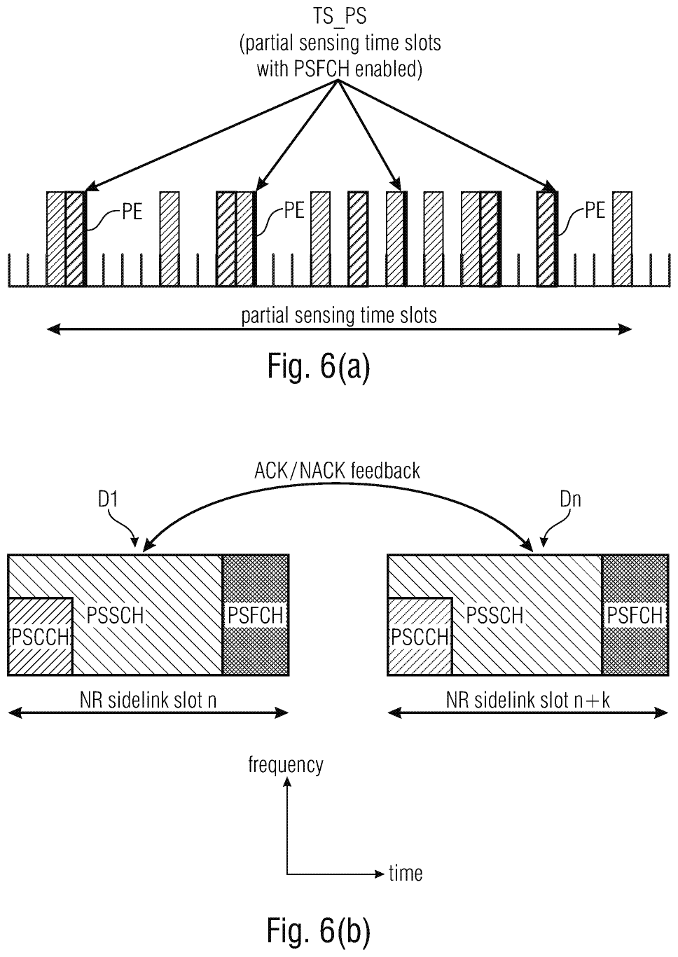

According to embodiments, this solution makes sense especially when expecting feedback from multiple RX UEs, hence bundling feedback and receiving them in time slots that correspond to the above criteria enhances the power saving capabilities of the TX UE. An example of this can be seen in FIG. 6a.

FIG. 6a shows a plurality of subsequent timeslots, wherein some timeslots are marked/used for partial sensing (cf. TS_PS). Here, PSFCH may be enabled as illustrated by the lines marked by PE.

Note according to embodiments, it is possible to only monitor the one or more feedback symbols and not the whole timeslot, as it is illustrated by FIG. 6b. FIG. 6b show two subsequent data packets D1 and Dn, each comprising PSCCH, PSSCH, PSFCH, being transmitted in time slot n and n+k respectively. As illustrated by the arrow, the feedback portion in the time slot n+k refers to the feedback that is sent by the receiving UE for the data transmission that took place in the data portion PSSCH of the time slot n.

According to embodiments, the transceiver transmitting the sidelink transmission determines the certain time slots defined or indicated by the configuration information based on a resource pool configuration information, which includes parameters such as the resource reservation periods supported by the resource pool, and/or the periodicity of the PSFCH; additionally or alternatively wherein the transceiver is configured to activate the sensing, to activate the receiver of the transceiver and/or to activate the transmitter of the transceiver for the one or more timeslots; and/or wherein the transceiver transmitting the sidelink transmission and expecting the feedback monitors the one or more certain timeslots derived from the configuration information and/or the resource pool (RP) configuration. The time slots where the UEs carry out partial sensing is derived from the RP configuration.

According to embodiments, the transceiver monitors feedback on the PSFCH channel alone, in the timeslots where the feedback is expected for a previous transmission and is not a part of the subset of timeslots. For example, the UE is expected to monitor for feedback for a transmission carried out in slot n, only in slot n+k, where the feedback is expected, as already seen in FIG. 6b. Here, k (e.g. defined by the number of slots) is based on configurations and is known to both the TX and RX UEs.

According to embodiments, the transceiver receiving the sidelink transmission uses the one or more certain timeslots derived from the configuration information for transmitting the receive feedback. According to embodiments, the one or more timeslots are timeslots indicated for partial sensing.

According to embodiments, the configuration information indicates that the receive feedback is transmitted in only those timeslots that meet one or more of the following criteria:
the one or more timeslots are one of the partial sensing timeslots;
the one or more timeslots are one with PSFCH configured and enabled (based on SL-PSFCH-period-R16);
the one or more timeslots are within the PDB of the transmitted sidelink transmission.

Another embodiment provides a respective user equipment comprising a transceiver according to this concept.

According to further embodiments, the concept of aspect 3 may be implemented as a method. Here, the method comprises the following steps:
performing a sidelink transmission with restricted sidelink reception and/or full reception,
transmitting or receiving a feedback (HARQ feedback) using only one or more certain timeslots being a proper subset of all available timeslots, wherein the only one or more certain timeslots are defined or indicated by a configuration information and/or resource pool (RP) configuration.

### Aspect 4—Permitting/Restricting the Reception of HARQ Feedback Based on the DRX Configuration of the TX UE

According to another embodiment, the transceiver of a type B or D user equipment is provided. The transceiver is configured for a sidelink transmission. Furthermore, the transceiver is configured for a sidelink reception only during active duration based on a provided SL DRX configuration. The transceiver is configured to transmit or receive a feedback (HARQ) using only one or more certain timeslots (e.g., of proper subset of claims), wherein the one or more certain timeslots are restricted as timeslots for which a physical sidelink feedback channel (PSFCH) is enabled and/or as timeslots within the active duration.

Embodiments of this aspect are based on the finding that the SL DRX configuration of the TX UE, which expects a feedback, enables that the timeslots within which the feedback is expected can be limited or restricted to timeslots which already belong to an active duration (for example, during the ON duration) or which are marked as timeslots where the physical sidelink feedback control channel is enabled. Note that the timeslots where the feedback is expected may be within the active duration of the receiver/transmitter entity of the transceiver or may be outside the active duration, somewhere within the sidelink DRX cycle, e.g., between the ON duration and the subsequent ON duration. As discussed with respect to aspect 3, the beneficial approach enables to save energy, since the respective TX UE waiting for the feedback just has to enable the receiver unit for a certain timeslot within which the feedback is expected.

Background of Aspect 4 will be discussed below. Another power saving mechanism that is currently being discussed in Rel-17 is SL DRX. In this discontinuous reception mode, the UE receives only during the configured active duration. The active duration consists of the ON duration and any further extension due to the inactivity timer being triggered. When incorporating HARQ feedback, the question is whether the UE should extend the active duration to receive HARQ feedback, or go to sleep and then wake up only for receiving the feedback. This feature is possible only for Type B or Type D UEs, which are capable of PSFCH reception.

As already discussed above, there are two options that slightly differ from each other. According to a first option of this aspect 4, the feedback is expected within an active duration, e.g., an ON duration: DRX cycles are designed to restrict PSFCH reception only during active durations. In this case, the feedback is transmitted in any of the PSFCH enabled time slots within the active duration. It is also possible for the UE to aggregate feedback and transmit the feedback in the slot before the end of the active duration. For example, if the active duration ends at time slot 10, the feedback is sent at the end of time slot 9.

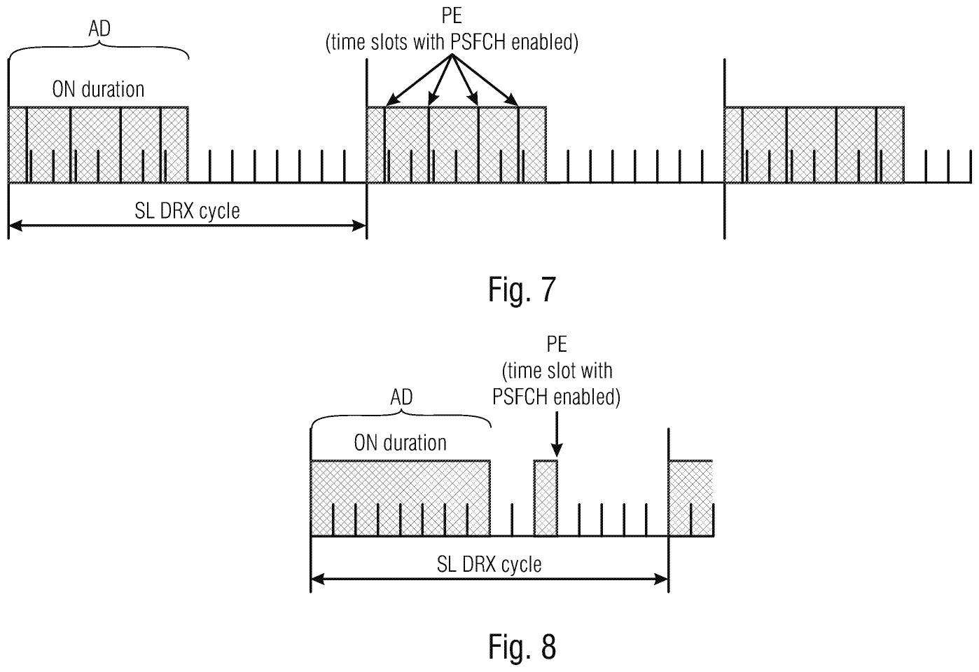

Within FIG. 7, the ON duration/active duration is marked by AD, wherein time slots with PSFCH enabled are marked by PE. As can be seen, all timeslots PE are arranged within the ON duration, for example, at the end of each second timeslot (last symbols of each second timeslots) of the ON duration/active duration.

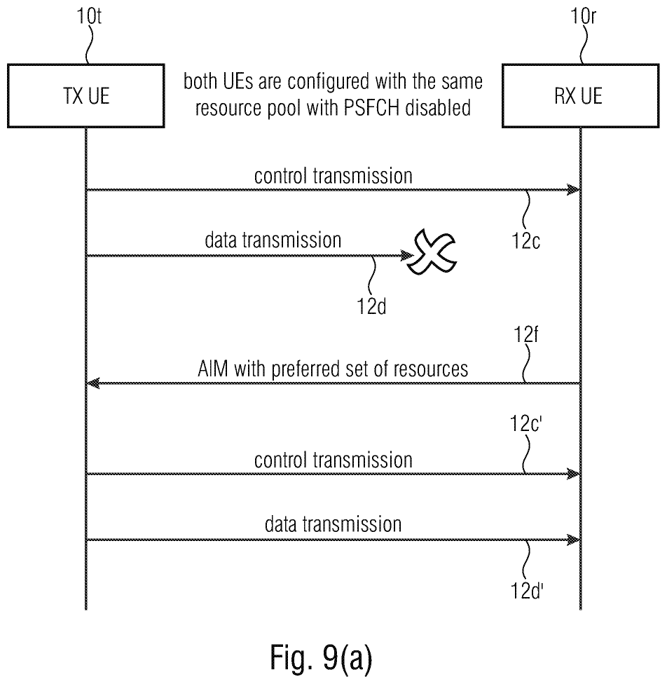

According to another option, the timeslot with PSFCH enabled (generally referred to as feedback timeslot) can be arranged outside the active duration AD, for example three timeslots after the active duration AD. This means that feedback can be received even when not within the active duration. The UE will go into a “light sleep” mode during the off duration when not expecting to receive the PSFCH. This is illustrated by FIG. 8 showing the ON duration AD a subsequent timeslot PE that lies outside the active duration AD. In this case, the UE can also just receive the symbols with PSFCH (PE) and not the entire time slot.

According to embodiments, the transceiver monitors for feedback on the relevant PSFCH enabled time slots only when it is expecting feedback, for one or more previous transmissions.

According to embodiments, the active duration is defined as the time period in which one or more of the following apply:
DRX ON duration,
HARQ Retransmission timer,
Inactivity timer,
Duration for sensing procedures.

According to embodiments, the ON duration, the timeslots for the end of the ON duration and the duration of the DRX cycle are defined based on the SL DRX configuration of the transmitting user equipment; and wherein the timeslots for which physical sidelink feedback control channel (PSFCH) is enabled are defined or indicated by the resource pool configuration information. The SL DRX configuration can be provided by the transmitting UE to the receiving UE when out of coverage of the base station (gNB), for example, in the case of unicast transmissions, or can also be provided by the base station (gNB) when the UEs are in coverage. It is also possible for the UEs to be pre-configured with the SL DRX configuration.

According to embodiments, the timeslots belonging to the active duration are the timeslots used or reserved for the sidelink transmission or sidelink reception. According to embodiments, the one or more timeslots for which physical sidelink feedback control channel (PSFCH) is enabled lies within one or more timeslots of the active duration or outside the active duration.

According to embodiments, the transceiver transmitting the feedback is configured to transmit only within the active duration, and only in the time slots with PSFCH enabled; and/or wherein the transceiver receiving the feedback is configured to monitor the time slots with PSFCH enabled within the active duration.

According to embodiments, the transceiver transmitting the feedback can aggregate the feedback to be transmitted within the active duration, and transmit the aggregated feedback at the end of the active duration; and/or wherein the transceiver receiving the feedback is configured to monitor the time slot with PSFCH enabled at the end of the active duration.

According to embodiments, the transceiver transmitting the feedback is configured to activate the transmitter of the transceiver for the one or more timeslots; alternatively the transceiver receiving the feedback is configured to wake up or perform a light sleep or full sleep, as defined by the DRX configuration, for the one or more timeslots for which physical sidelink feedback control channel (PSFCH) reception is enabled or to activate the receiver of the transceiver.

According to embodiments, the transceiver transmitting the feedback is configured to transmit on any time slot within the DRX cycle, and only in time slots with PSFCH enabled; and/or wherein the transceiver receiving the feedback is configured to
monitor the time slots with PSFCH enabled within the active duration, and
wake up and monitor the time slots with PSFCH enabled outside the active duration.

In this case as well, the UE can send aggregated feedback in the time slots with PSFCH enabled outside the active duration.

According to embodiments, the transceiver performs a light sleep, or full sleep, for the time slots that are outside the active duration and the time slots that do not have PSFCH enabled.

Another embodiment provides a user equipment using this transceiver according to aspect 4.

Another embodiment provides a method for performing sidelink communication comprising the central method steps:
performing a sidelink transmission; and
performing a sidelink reception only during the active duration based on a provided DRX configuration,
transmitting or receiving a feedback (HARQ feedback) using only one or more certain timeslots of a proper subset of timeslots, wherein the one or more certain timeslots are restricted as timeslots for which physical sidelink feedback control channel (PSFCH) is enabled and/or as timeslots within the active duration.

### Aspect 5—Using the AIMs to Transmit Consolidated/Aggregated Feedback

According to an embodiment, a transceiver of a type B or type D user equipment is provided. The transceiver for configured for sidelink transmission with restricted sidelink reception and/or full reception and/or based on a SL DRX configuration. The transceiver is further configured to transmit or receive (dependent on the current role as TX UE or RX UE) a feedback using an assistance information message (AIM).

Embodiments of this aspect are based on the principle that so-called assistance information, which is exchanged between different user equipments communicating via a sidelink, can be used for transmitting a feedback, ACK or NACK. This helps to improve the energy efficiency, since the transceivers are typically enabled for receiving, transmitting or, in general, exchanging the assistance information message.

Below, examples for AIMs may be given. An AIM may include information for supporting an operation of a UE over the sidelink. For example, for the operation over the SL, the UE may obtain, in addition to the resource allocation information or instead of the resource allocation information, one or more link related assistance information, distance related assistance information, geographically area related assistance information, group related assistance information, relay related assistance information. Furthermore, quality specific information, like the link quality information comparable to the CSI (or including the CSI) may be exchanged using AIM.

Below, the background of the present aspect will be discussed. Since AIMs are also being discussed in Rel-17, we propose to use these AIMs as a means to inform the TX UE about the status of the transmitted TB.

This can be applied for power saving UEs that are either required to transmit a message with feedback, but cannot find resources in a resource pool with PSFCH enabled. In NR-U, it is also possible that the UE cannot transmit the feedback on the PSFCH because the channel is blocked or busy. It is also possible that the TX UE requires to save power and not carry out sensing, for which it needs the RX UE to provide resources to be used for the retransmission of a failed TB transmission.

In either of these cases, we propose that the UE can then use a resource pool with PSFCH disabled for the transmission of a TB, and expect the feedback of the transmission in the AIM. This can be applicable for all the types of UEs, carrying out either random resource selection or partial sensing, including type A, B or D UEs. The RX UE does not use the PSFCH at all for the transmission of the feedback, but uses AIMs instead.

For example, if a TX UE transmitted a packet to an RX UE, if the RX UE received the packet successfully, the RX UE can choose to not send anything back as a confirmation to the TX UE. In the case that the packet reception failed, the RX UE can send an AIM to the TX UE consisting of a set of advantageous resources. This will provide the TX UE with available resources (as according to the RX UE) to use for the retransmission of the failed packet back to the RX UE.

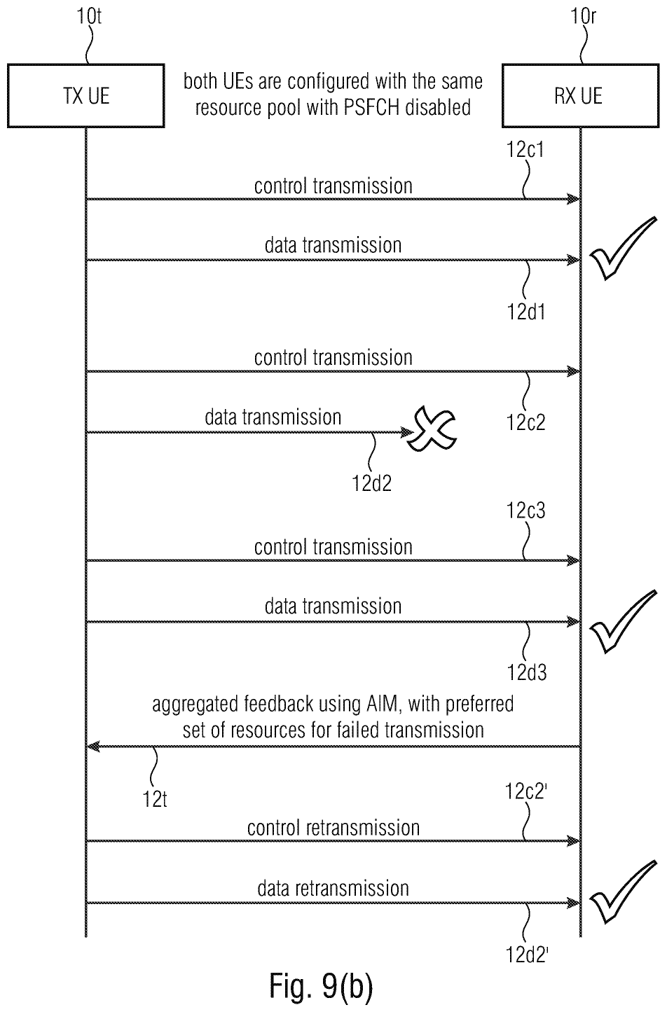

Below, taking reference to FIGS. 9a and 9b, the concept of using the AIM will be discussed. Below, two UEs, one TX UE 10t and one RX UE 10r are shown. Both UEs 10t and 10r are configured with the same resource pool with PSFCH disabled. The TX UE 10t transmits control information 12c followed by data 12d, wherein the data transmission 12d fails. As feedback the RX UE 10r provides an AIM with an advantageous set of resources as feedback. Then the UE 10t uses these advantageous sets of resources and performs a retransmission, here 12c′ and 12d′.

This concept can be taken further when the feedback for each TX-RX pair can be aggregated. In this case, the HARQ status of each of the active HARQ processes, corresponding to different HARQ IDs, are sent by the RX UE to the TX UE using AIMs. This can be in a time slot that is within the partial sensing time slots and/or the ON duration of a configured DRX cycle to maximize power saving.

According to further embodiments, the feedback may be aggregated as illustrated by FIG. 9b. Within FIG. 9b, a successful first transmission 12cl and 12dl and successful third transmission 12c3 and 12d3 is performed from the UE 10t to the UE 10r and a failed transmission 12d2.

After the third transmission, an aggregated feedback 12t using AIM is transmitted from the receiver 10r to the transmitter 10t. Advantageously the AIM includes an advantageous set of resources for failed retransmission alone. This retransmission is then performed afterwards (cf. 12c2′ and 12d2′). Note that the AIM 12t can just comprise the information regarding the failed transmission, especially regarding 12d2 or also the information regarding the successful transmission of 12d1 and 12d3.

According to further embodiments, the assistance information message containing the feedback is used when the physical sidelink feedback control channel (PSFCH) is blocked, busy or disabled, or when the PSFCH is disabled for a given resource pool.

According to yet another embodiment, the assistance information message containing the feedback is used in addition or combination with the feedback from the PSFCH. In this case, the PSFCH will contain the ACK/NACK information pertaining to a transmission, followed by an AIM providing either an advantageous or not advantageous set of resources for attempting a retransmission of a failed packet. The following combinations of the AIM and PSFCH are possible:
Both SL AIM+PSFCH are transmitting the same information to increase the reliability, NACK or ACK,
PSFCH transmits the NACK and SL AIM transmits the potentially new resource to be used for the retransmission,
SL AIM transmits the NACK and the PSFCH transmits the potentially new resource to be used for the retransmission,
Any combination of the above, to increase reliability.

According to embodiments, the feedback comprises one or more of the following:
ACK or NACK information pertaining to the status of the received transmission,
In the case of a NACK, information on resources that should or should not be used for a retransmission of a data packet transmitted using a sidelink transmission.

According to embodiments, the transceiver can aggregate the feedback status of a configured or preconfigured number of transmissions, and send the aggregated feedback using the assistance information message, and wherein the assistance information message will contain information on resources that should or should not be used for a retransmission of the failed data packets.

According to embodiments, the assistance information message is used for a retransmission of a data packet transmitted using a sidelink transmission.

Another embodiment provides a user equipment comprising a transceiver according to the fifth aspect.

Another embodiment provides a method for performing sidelink transmission with restricted sidelink reception or full reception or based on a SL DRX configuration. The method comprises the basic step of transmitting or receiving feedback using an assistance information message.

As already discussed in the context of UE of type A, the aspects 1 and 2 may be combined. Analogously, a UE of type B or type D (cf. 10b or 10d) may use the principles as discussed in the context of aspect 3 in combination with the principles of aspect 4 or 5. Furthermore, a UE 10b or 10d using the principle of aspect 4 may also use the principle of aspect 5.

Therefore, embodiments provide a transceiver wherein the transmitter is configured for a sidelink transmission without sidelink reception; wherein the transmitter is configured to perform random resource selection for the sidelink transmission in a resource pool with random resource selection enabled, wherein the random resource selection is limited to a resource pool with disabled physical sidelink feedback channel (PSFCH disabled); and wherein the transmitter is configured for sidelink transmission without sidelink reception and for blind retransmission of a data packet already transmitted using the sidelink transmission; wherein the number of retransmissions are performed dependent on one or more criteria.

Further embodiments provide a transceiver wherein the transceiver is configured for a sidelink transmission with restricted sidelink reception and/or full reception, wherein the transceiver is configured to transmit or receive a feedback (HARQ feedback) using only one or more certain timeslots being a proper subset of all available timeslots, wherein the only one or more certain timeslots are defined or indicated by a configuration information and/or resource pool (RP) configuration; and wherein the transceiver is configured for a sidelink transmission; wherein the transceiver is configured for a sidelink reception only during the active duration based on a provided DRX configuration, wherein the transceiver is configured to transmit or receive a feedback (HARQ feedback) using only one or more certain timeslots of a proper subset of timeslots, wherein the one or more certain timeslots are restricted as timeslots for which physical sidelink feedback control channel (PSFCH) receipt is enabled and/or as timeslots within the active duration; or wherein the transceiver is configured to transmit or receive a feedback using an assistance information message.

Further embodiments provide a transceiver of a (type B or D) user equipment, UE. The transceiver is configured for a sidelink transmission and for a sidelink reception only during the active duration based on a provided DRX configuration. Further, the transceiver is configured to transmit or receive a feedback (HARQ feedback) using only one or more certain timeslots of a proper subset of timeslots, wherein the one or more certain timeslots are restricted as timeslots for which physical sidelink feedback control channel (PSFCH) receipt is enabled and/or as timeslots within the active duration; here, the transceiver is configured for a sidelink transmission with restricted sidelink reception and/or full reception, and to transmit or receive a feedback using an assistance information message.

### Embodiments

User equipment comprising a transmitter (11tx) according to according to any of the previous claims.

User equipment, wherein the user equipment comprises a sensor, a GNSS sensor or a receiver for receiving a signal of a synchronization source or a synchronization signal of a base station; and/or
wherein the user equipment is capable of transmission and reception to a base station, especially using the Uu interface.

Transceiver (11tr) of a (type B or D) user equipment (10b, 10d), UE, wherein the transceiver (11tr) is configured for a sidelink (SL) transmission with restricted sidelink (SL) reception and/or full sidelink (SL) reception and/or based on a SL DRX configuration;
wherein the transceiver (11tr) is configured to transmit or receive a feedback using only one or more certain timeslots being a proper subset of all available timeslots, wherein the only one or more certain timeslots are defined or indicated by a configuration information.

Transceiver (11tr), wherein the transceiver (11tr) transmitting the sidelink (SL) transmission determines the certain time slots defined or indicated by the configuration information based on a resource pool configuration information,
wherein the resource pool configuration information includes parameters such as the parameters indicating the resource reservation periods supported by the resource pool, and/or the periodicity of the PSFCH.

Transceiver (11tr), wherein the transceiver (11tr) is configured to activate the sensing, to activate the receiver of the transceiver (11tr) and/or to activate the transmitter (11tx) of the transceiver (11tr) for the one or more timeslots; and/or
wherein the transceiver (11tr) transmitting the sidelink (SL) transmission and expecting the feedback monitors the one or more certain timeslots derived from the configuration information and/or the resource pool configuration.

The transceiver (11tr), wherein the transceiver (11tr) monitors feedback on the PSFCH channel alone, in the timeslots where the feedback is expected for a previous transmission and is not a part of the subset of timeslots.

Transceiver (11tr), wherein the transceiver (11tr) receiving the sidelink (SL) transmission uses the one or more certain timeslots derived from the configuration information for transmitting the receive feedback.

Transceiver (11tr), wherein the one or more timeslots are timeslots indicated for partial sensing.

Transceiver (11tr), wherein the configuration information indicates that the receive feedback is transmitted in only those timeslots that meet one or more of the following criteria:
the one or more timeslots are one of the partially sensing timeslots;
the one or more timeslots are one with PSFCH configured;
the one or more timeslots are within the PDB of the transmitted sidelink (SL) transmission.

Transceiver, wherein the transceiver (11tx) transmitting the sidelink (SL) transmission determines the certain time slots defined or indicated by the configuration information based on a resource pool configuration information and/or a SL DRX configuration;
wherein the resource pool configuration information includes parameters such as the parameters indicating the periodicity of the PSFCH, which indicate time slots for which the physical sidelink (SL) feedback control channel (PSFCH) is enabled; and/or
wherein the SL DRX configuration information includes parameters such as the parameters indicating the time slots that are within an active duration (AD).

Transceiver (11tr), wherein the transceiver (11tr) monitors for feedback on the relevant PSFCH enabled time slots only when it is expecting feedback, for one or more previous transmissions.

Transceiver (11tr), wherein the active duration (AD) is defined as the time period in which one or more of the following apply:
DRX ON duration,
HARQ retransmission timer,
Inactivity timer,
Duration for sensing procedures.

Transceiver (11tr), wherein the DRX ON duration, the timeslots for the end of the ON duration and the duration of the DRX cycle are defined based on the DRX configuration of the transmitting user equipment or the base station or based on a pre-configuration.

Transceiver (11tr), wherein the timeslots for which physical sidelink (SL) feedback control channel (PSFCH) is enabled are defined or indicated by the resource pool configuration information.

Transceiver (11tr), wherein the timeslots belonging to the active duration (AD) are the timeslots used or reserved for the sidelink (SL) transmission or sidelink (SL) reception.

Transceiver (11tr), wherein the one or more timeslots for which physical sidelink (SL) feedback control channel (PSFCH) is enabled lies within one or more timeslots of the active duration (AD) or outside the active duration (AD).

Transceiver (11tr), wherein the transceiver (11tr) transmitting the feedback is configured to transmit only within the active duration (AD), and only in the time slots with PSFCH enabled; and/or wherein the transceiver (11tr) receiving the feedback is configured to monitor the time slots with PSFCH enabled within the active duration (AD).

Transceiver (11tr), wherein the transceiver (11tr) transmitting the feedback can aggregate the feedback to be transmitted within the active duration (AD), and transmit the aggregated feedback at the end of the active duration (AD); and/or
wherein the transceiver (11tr) receiving the feedback is configured to monitor the time slot with PSFCH enabled at the end of the active duration (AD).

Transceiver (11tr), wherein the transceiver (11tr) transmitting the feedback is configured to activate the transmitter (11tx) of the transceiver (11tr) for the one or more timeslots; and/or
wherein the transceiver (11tr) receiving the feedback is configured to wake up or perform a light sleep for the one or more timeslots for which physical sidelink (SL) feedback control channel (PSFCH) is enabled or to activate the receiver of the transceiver (11tr).

Transceiver (11tr), wherein the transceiver (11tr) transmitting the feedback is configured to transmit on any time slot within the DRX cycle, and only in time slots with PSFCH enabled; and/or wherein the transceiver (11tr) receiving the feedback is configured to
monitor the time slots with PSFCH enabled within the active duration (AD), and/or
wake up and monitor the time slots with PSFCH enabled outside the active duration (AD).

Transceiver (11tr), wherein the transceiver (11tr) performs a light sleep for the time slots that are outside the active duration (AD) and the time slots that do not have PSFCH enabled.

User equipment (10b, 10d) comprising a transceiver (11tr).

Method for transmitting and/or receiving a sidelink (SL) transmission by use of a (type B or D) user equipment, comprising the following steps:
performing sidelink (SL) transmission with restricted sidelink (SL) reception and/or full sidelink (SL) reception and/or based on a SL DRX configuration;
transmitting or receiving a feedback using only one or more certain timeslots being a proper subset of all available timeslots, wherein the only one or more certain timeslots are defined or indicated by a configuration information.

Transceiver (11tr) of a (type B or type D) user equipment (10b, 10d), UE,
wherein the transceiver (11tr) is configured for a sidelink (SL) transmission with restricted sidelink (SL) reception and/or full reception and/or based on a SL DRX configuration,
wherein the transceiver (11tr) is configured to transmit or receive a feedback using an assistance information message.

Transceiver (11tr), wherein the assistance information message containing the feedback is used when the physical sidelink (SL) feedback control channel (PSFCH) is blocked, busy or disabled, or when the PSFCH is disabled for a given resource pool.

Transceiver (11tr), wherein the assistance information message containing the feedback is used in addition/combination with the physical sidelink (SL) feedback control channel (PSFCH).

Transceiver (11tr), wherein both the assistance information message (SL AIM) and a Physical Sidelink Feedback Channel (PSFCH) are transmitting the same information (to increase the reliability, e.g. NACK and/or ACK); and/or
wherein the Physical Sidelink Feedback Channel (PSFCH) transmits an NACK and the assistance information message (SL AIM) transmits the potentially new resource to be used for the retransmission; and/or
wherein the assistance information message (SL AIM) transmits an NACK and the Physical Sidelink Feedback Channel (PSFCH) transmits the potentially new resource to be used for the retransmission.

Transceiver (11tr), wherein the feedback comprises one or more of the following:
ACK or NACK information pertaining to the status of the received transmission,
In the case of a NACK, information on resources that should or should not be used for a retransmission of a data packet transmitted using a sidelink (SL) transmission.

Transceiver (11tr), wherein the transceiver (11tr) can aggregate the feedback status of a configured or preconfigured number of transmissions, and send the aggregated feedback using the assistance information message.

Transceiver (11tr), wherein the assistance information message will contain information on resources that should or should not be used for a retransmission of the failed data packets.

Transceiver (11tr), wherein the assistance information message is used for a retransmission of a data packet transmitted using a sidelink (SL) transmission.

Transceiver (11tr), wherein the transceiver (11tr) is configured for a sidelink (SL) transmission with restricted sidelink (SL) reception and/or full sidelink (SL) reception and/or based on a SL DRX configuration;
wherein the transceiver (11tr) is configured to transmit or receive a feedback using only one or more certain timeslots being a proper subset of all available timeslots, wherein the only one or more certain timeslots are defined or indicated by a configuration information.

User equipment (10b, 10d) comprising a transceiver (11tr) according one of claims 34-42.

Method for performing sidelink (SL) transmission with restricted sidelink (SL) reception, full reception or partially sensing using a (type B or D) user equipment, the method comprising the following steps:
transmitting or receiving receive feedback using an assistance information message.

The user device, UE, wherein the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g, a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink (SL) relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink (SL) the wireless communication network, e.g. a sensor or actuator, or a transceiver (11tr), or any sidelink (SL) capable network entity.

Method for performing a sidelink (SL) transmission by use of a (type A) user equipment, comprising the following steps:
performing sidelink (SL) transmission without sidelink (SL) reception with random resource selection enabled; and performing random resource selection for the sidelink (SL) transmission, wherein the random source selection is limited to a resource pool with disabled physical sidelink (SL) feedback channels; and/or
performing the sidelink (SL) transmission without sidelink (SL) reception; and performing a blind retransmission of a data packet already transmitted using the sidelink (SL) transmission; wherein the number of retransmissions are performed dependent on one or more criteria.

The user device, UE, wherein the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g, a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink (SL) relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink (SL) the wireless communication network, e.g. a sensor or actuator, or a transceiver (11tr), or any sidelink (SL) capable network entity.

The user device, UE, wherein the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g, a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink (SL) relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink (SL) the wireless communication network, e.g. a sensor or actuator, or a transceiver (11tr), or any sidelink (SL) capable network entity.

A wireless communication system comprising at least one, advantageously more, user equipments according to the invention.

The wireless communication system, comprising one or more base stations, wherein the base station comprises one or more of a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Computer program for performing, when running on a computer, a method according to the invention.

General

Another embodiment refers to a wireless communication system comprising one or more of the above discussed user equipments 10A, 10B or 10D. According to further embodiments, the communication system may comprise one or more base stations. Here, the base station comprises one or more of a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Examples for such a communication system are sidelink communication systems, e.g., V2x, as in the context of cellular (e.g., 3G, 4G, 5G or future), public safety communication systems, compost networks or ad hoc communication networks.

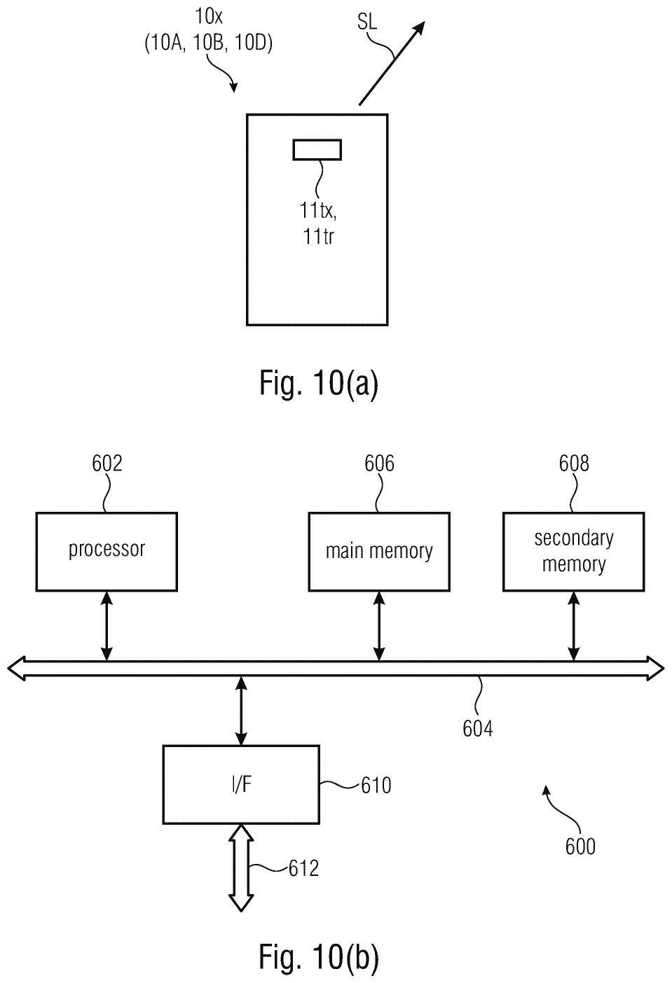

As discussed above, all aspects can be implemented by use equipment or a transmitter/transceiver of the UE. There are different types of use equipment 10A belonging to type A, 10B belong to Type B and 10D belonging to type D. FIG. 10a show an exemplary user equipment 10x, usable as a type A, type B and/or type D, comprising a transceiver 11tr or transmitter 11 tx for sidelink communications SL.

Regarding user equipment, it should be noted that according to embodiments, same may be out of the group of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

Note all above discussed use equipment may be configured to exchange data with a base station (transmission and/or reception), e.g. using the UU interface.

Above, it has been discussed that the aspects 1-5 may be implemented by a method. Of course, the method may be computer implemented as will be discussed below.

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

Although some of the embodiments above are described with reference to a Mode 2 UE, it is noted that the present invention is not limited to such embodiments. The teachings of the present invention as described herein are equally applicable to Mode 1 UEs carrying out sensing to obtain, e.g., a sensing report for providing an occupancy status of one or more resources or resource sets and transmitting AIMs. For example, Mode 1 UEs may aid in performing sensing for Mode 2 UEs, e.g. if operating in the same frequency band. A mode 1 UE may also be a fixed RSU which has a wired power supply, and which may, if idling in mode 1, perform services for mode 2 UEs.

Although some of the embodiments above are described with reference to a sidelink pool, it is noted that the present invention is not limited to such embodiments. Rather, the inventive approach may be implemented in a system or network providing a set or resources to be used for a certain communication between entities in the network, and the set of resources may be preconfigured so that the entities of the network are aware of the set of resources provided by the network, or the entities may be configured by the network with the set of resources. The set of resources provided by the network may be defined as one or more of the following:
a sidelink resource pool, to be used by the UE for sidelink communications, e.g. direct UE-to-UE communication via PC5,
a configured grant including or consisting of resources to be used by the UE for NR—U communications,
a configured grant including or consisting of resources to be used a reduced capability UE.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10b illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF ACRONYMS AND SYMBOLS

V2X Vehicle-to-Everything
3GPP Third Generation Partnership Project
D2D Device-to-Device
AIM Assistance Information Message
PC5 Sidelink Interface
BS Base Station
gNB Evolved Node B (NR base station)
UE User Equipment
SL Sidelink
V2V Vehicle-to-Vehicle
SIB System Information Block
RB Resource Block
PSCCH Physical Sidelink Control Channel
PSSCH Physical Sidelink Shared Channel
RRC Radio Resource Control
SCI Sidelink Control Information

1. Transmitter of a (type a) user equipment, UE,
wherein the transmitter is configured for a sidelink (SL) transmission without sidelink (SL) reception and wherein the transmitter is configured for blind retransmission of a data packet already transmitted using the sidelink (SL) transmission, wherein the number of retransmissions are performed dependent on one or more criteria; or
wherein the transmitter is configured to perform random resource selection for the sidelink (SL) transmission, wherein the random resource selection is limited to a resource pool with random resource selection enabled, wherein a physical sidelink (SL) feedback channel is disabled and wherein the transmitter is configured for blind retransmission of a data packet already transmitted using the sidelink (SL) transmission, wherein the number of retransmissions are performed dependent on one or more criteria.

2. Transmitter according to claim 1, wherein the resource pool is preconfigured by a pre-configuration or configured by a configuration with one or more of the following:
PSFCH disabled and/or resources of the resource pool with PSFCH disabled, and/or
random resource selection enabled.

3. Transmitter according to claim 2, wherein a pre-configuration or configuration comprises a flag indicating that the resource pool with PSFCH disabled is usable just with disabled feedback.

4. Transmitter according to claim 1, wherein the resource pool with PSFCH disabled and random resource selection enabled is useable only for user equipments having feedback disabled, while carrying out random resource selection.

5. The transmitter according to claim 1, wherein the criteria are out of the group comprising one or more of the following:
a priority for the data packet,
one or more characteristics of a packet of a transmission,
a logical channel used for a transmission,
a logical channel group used for a transmission,
a quality-of-service, QoS, flow,
a quality-of-service, QoS, requirement associated with a transmission, like a priority or delay or data rate,
the type of UE, e.g. V-UE, PS-UE, IIoT UE, low power UE,
one or more resources to be used by an initial transmission and/or at least one further transmission,
the cast type, e.g., unicast, groupcast or broadcast, used for the initial transmission,
a current battery status of the UE.

6. Transmitter according to claim 1, wherein the retransmissions are performed n times, with 0<=n<=nᵣₑₜᵣₐₙₛₘᵢₛₛᵢₒₙₛ, wherein n is configured for each of the priority classes or another priority relevant information or said criteria.

7. Transmitter according to claim 1, wherein the transmitter performs the retransmissions, wherein the number of retransmissions is dependent on the priority classes or another priority relevant information or said criteria.

8. The transmitter according to claim 1, wherein the number of retransmissions performed by the transmitter can be configured based on a configured or pre-configured priority threshold.

9. Transmitter according to claim 1, wherein the priority depends on the content of the data packet; and/or
wherein the priority is set to high for a data packet comprising an emergency information, set to normal for a data packet comprising regular data transmission (like a status information) or set to low for low important content (like an iterative information/iterative measurement information).

10. Transceiver of a (type B or D) user equipment, UE,
wherein the transceiver is configured for a sidelink (SL) transmission with restricted sidelink (SL) reception and/or full sidelink (SL) reception and/or based on a SL DRX configuration;
wherein the transceiver is configured to transmit or receive a feedback using only one or more certain timeslots being a proper subset of all available timeslots, wherein the only one or more certain timeslots are defined or indicated by a configuration information.

11. Transceiver according to claim 10, wherein the transceiver transmitting the sidelink (SL) transmission determines the certain time slots defined or indicated by the configuration information based on a resource pool configuration information,
wherein the resource pool configuration information comprises parameters such as the parameters indicating the resource reservation periods supported by the resource pool, and/or the periodicity of the PSFCH; and/or
wherein the transceiver is configured to activate the sensing, to activate the receiver of the transceiver and/or to activate the transmitter of the transceiver for the one or more timeslots; and/or
wherein the transceiver transmitting the sidelink (SL) transmission and expecting the feedback monitors the one or more certain timeslots derived from the configuration information and/or the resource pool configuration

12. Transceiver according to claim 10, wherein the transceiver transmitting the sidelink (SL) transmission determines the certain time slots defined or indicated by the configuration information based on a resource pool configuration information and/or a SL DRX configuration;
wherein the resource pool configuration information comprises parameters such as the parameters indicating the periodicity of the PSFCH, which indicate time slots for which the physical sidelink (SL) feedback control channel (PSFCH) is enabled;
and/or wherein the SL DRX configuration information comprises parameters such as the parameters indicating the time slots that are within an active duration (AD).

13. Transceiver according to claim 10, wherein the transceiver monitors for feedback on the relevant PSFCH enabled time slots only when it is expecting feedback, for one or more previous transmissions; and/or
wherein the active duration (AD) is defined as the time period in which one or more of the following apply:
DRX ON duration,
HARQ retransmission timer,
Inactivity timer,
Duration for sensing procedures.

14. Transceiver according to claim 10, wherein the one or more timeslots are timeslots indicated for partial sensing.

15. Transceiver of a (type B or type D) user equipment, UE,
wherein the transceiver is configured for a sidelink (SL) transmission with restricted sidelink (SL) reception and/or full reception and/or based on a SL DRX configuration,
wherein the transceiver is configured to transmit or receive a feedback using an assistance information message.

16. Transceiver according to claim 15, wherein the assistance information message comprising the feedback is used when the physical sidelink (SL) feedback control channel (PSFCH) is blocked, busy or disabled, or when the PSFCH is disabled for a given resource pool; and/or
wherein the assistance information message comprising the feedback is used in addition/combination with the physical sidelink (SL) feedback control channel (PSFCH); and/or
wherein both the assistance information message (SL AIM) and a Physical Sidelink Feedback Channel (PSFCH) are transmitting the same information (to increase the reliability, e.g. NACK and/or ACK); and/or
wherein the Physical Sidelink Feedback Channel (PSFCH) transmits an NACK and the assistance information message (SL AIM) transmits the potentially new resource to be used for the retransmission; and/or
wherein the assistance information message (SL AIM) transmits an NACK and the Physical Sidelink Feedback Channel (PSFCH) transmits the potentially new resource to be used for the retransmission.

17. Transceiver according to claim 15, wherein the transceiver performs a light sleep for the time slots that are outside the active duration (AD) and the time slots that do not have PSFCH enabled.
